(19) United States
(12) Patent Application Publication
(10) Pub. No.: US 2014/0175696 A1
(43) Pub. Date: Jun. 26, 2014

(54) System and Method for Forming Fiber Reinforced Polymer Tape

(71) Applicant: Ticona LLC, Florence, KY (US)

(72) Inventors: Cole Thomas Foor, Newport, KY (US); David W. Eastep, Winona, MN (US); Richard Frank Gregory, Union, KY (US); Timothy L. Tibor, Winona, MN (US)

(73) Assignee: Ticona LLC, Florence, KY (US)

(21) Appl. No.: 14/102,986

(22) Filed: Dec. 11, 2013

Related U.S. Application Data
(60) Provisional application No. 61/740,001, filed on Dec. 20, 2012.

(51) Int. Cl. B29D 7/01

(52) U.S. Cl. CPC B29D 7/01
USPC 264/175; 425/112

(57) ABSTRACT

Systems and methods for forming fiber reinforced polymer tapes are disclosed. A method may include, for example, traversing a polymer impregnated roving through a system comprising an inlet and an outlet, applying a consolidation pressure within the system to the polymer impregnated roving, and applying a smoothing pressure within the system to the polymer impregnated roving. The method may further include adjusting a temperature of the polymer impregnated roving with a heat transfer device between the inlet and the outlet, the heat transfer device having a temperature different from a temperature of the polymer impregnated roving at the inlet.

### CROSS REFERENCE TO RELATED APPLICATIONS

The present application claims filing benefit of U.S. Provisional Patent application 61/740,001 having a filing date of Dec. 20, 2012 and which is incorporated by reference herein in its entirety.

### BACKGROUND OF THE INVENTION

Composite tapes and rods formed from fibers embedded in a polymer resin have been employed in a wide variety of applications. For example, such tapes, and more specifically rods formed from the tapes, may be utilized as lightweight structural reinforcements. One specific application of such rods is in the oil and gas industry, such as in subsea applications as well as in on-shore oil and gas production fields. In on-shore or subsea applications, for, example, multi-layer pipes may be utilized in risers, transfer lines, umbilicals and/or other suitable pipe assemblies. In production field applications, multi-layer pipes may be utilized in risers, infield flow lines, export pipelines and/or other suitable pipe assemblies. Power umbilicals, for example, are often used in the transmission of fluids and/or electric signals between the sea surface and equipment located on the sea bed. To help strengthen such umbilicals, attempts have been made to use pultruded carbon fiber rods as separate load carrying elements. Other applications of such rods may include, for example, use in high-voltage cables, tethers, etc. Applications of tapes may include, for example, use in high-pressure vessels to provide reinforcement thereof. In general, composite tapes and rods may be utilized in any suitable applications that may require, for example, high strength-to-weight elements, high corrosion resistance, and/or low thermal expansion properties.

There are many significant problems, however, with currently known methods and apparatus for producing composite tapes and rods. For example, composite tapes and rods are typically formed by impregnating fiber rovings with a polymer resin. Many rovings rely upon thermoset resins (e.g., vinyl esters) to help achieve desired strength properties. Thermoset resins are difficult to use during manufacturing and do not possess good bonding characteristics for forming layers with other materials. Further, attempts have been made to form impregnated rovings from thermoplastic polymers in other types of applications. U.S. Patent Publication No. 2005/0186410 to Bryant, et al., for instance, describes attempts that were made to embed carbon fibers into a thermoplastic resin to form a composite core of an electrical transmission cable. Unfortunately, Bryant, et al. notes that these cores exhibited flaws and dry spots due to inadequate wetting of the fibers, which resulted in poor durability and strength. Another problem with such cores is that the thermoplastic resins could not operate at a high temperature.

More recently, methods and apparatus have been developed that allow for the use of thermoplastic resins with fiber rovings to form composite tapes. However, these presently known methods and apparatus have in many cases resulted in further problems. For example, presently known methods and apparatus have resulted in composite tapes having undesirably high void levels. Additionally, presently known methods and apparatus are typically expensive and produce high levels of excess scrap.

One problem of particular concern during the formation of composite tapes using currently known methods and apparatus occurs during the consolidation of polymer impregnated fiber rovings into tapes. During such formation, the impregnated rovings must be consolidated and cooled to produce consolidated tapes. It is typically desirable to cool the impregnated rovings during consolidation thereof, in order to prevent later deconsolidation. However, currently known methods and apparatus for consolidating such rovings provide only minimal retention areas during consolidation for cooling of the rovings. To ensure that the rovings are adequately cooled during consolidation, the speeds at which the rovings are traversed through such consolidation apparatus are limited. These speed limitations thus reduce the overall production of composite tapes, resulting in losses in overall production goals and efficiency. Similar such issues exist when additional heating of rovings during consolidation is required.

Accordingly improved methods and apparatus for forming fiber reinforced polymer tapes are desired in the art. In particular, methods and apparatus that provide increased retention time and improved heat transfer during consolidation would be advantageous.

### SUMMARY OF THE INVENTION

In accordance with one embodiment of the present disclosure, a method for forming a fiber reinforced polymer tape is disclosed. The method includes traversing a polymer impregnated roving through a system comprising an inlet and an outlet, applying a consolidation pressure within the system to the polymer impregnated roving, and applying a smoothing pressure within the system to the polymer impregnated roving. The method further includes adjusting a temperature of the polymer impregnated roving with a heat transfer device between the inlet and the outlet, the heat transfer device having a temperature different from a temperature of the polymer impregnated roving at the inlet.

In accordance with another embodiment of the present disclosure, a system for forming a fiber reinforced polymer tape is disclosed. The system includes an inlet, and an outlet positioned downstream of the inlet. The system further includes a consolidation pressure device operable to apply a consolidation pressure to a polymer impregnated roving as the polymer impregnated roving is traversed between the inlet and the outlet. The system further includes a shaping pressure device operable to apply a shaping pressure to the polymer impregnated roving as the polymer impregnated roving is traversed between the inlet and the outlet. The system further includes a heat transfer device disposed between the inlet and the outlet, the heat transfer device operable to adjust a temperature of the polymer impregnated roving between the inlet and the outlet.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a side cross-sectional view of a consolidation system in accordance with one embodiment of the present disclosure;

FIG. 2 is a top view of a consolidation system in accordance with one embodiment of the present disclosure;

FIG. 3 is a side cross-sectional view of a consolidation system in accordance with another embodiment of the present disclosure;

FIG. 4 is a side cross-sectional view of a consolidation system in accordance with another embodiment of the present disclosure;

FIG. 5 is a side cross-sectional view of a consolidation system in accordance with another embodiment of the present disclosure;

FIG. 6 is a perspective view of a tape in accordance with one embodiment of the present disclosure; and

FIG. 7 is a cross-sectional view a tape in accordance with one embodiment of the present disclosure.

Repeat use of reference characters in the present specification and drawings is intended to represent the same or analogous features or elements of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

Generally speaking, the present disclosure is directed to systems and methods for forming fiber reinforced polymer tapes. In particular, the present disclosure is directed to consolidation systems and methods for forming fiber reinforced polymer tapes from one or more polymer impregnated rovings. The systems and methods according to the present disclosure advantageously provide increased retention time and improved heat transfer, such as cooling and/or heating, such that the speeds at which the polymer impregnated rovings are traversed through the systems and formed into fiber reinforced polymer tapes can be increased without any reductions in the quality of the resulting tapes. In exemplary embodiments, as discussed below, the ravings are constantly contacted and placed under various pressures during traversal through systems according to the present disclosure, such that constant heat transfer during increased retention times is facilitated. This allows for traversal speeds to be increased, thus increasing production and efficiency. In some embodiments, for example, when cooling is desirable, polymer impregnated rovings may enter systems according to the present disclosure at inlet temperatures generally above a melting temperature for the polymer material, such as in some embodiments between approximately 150° F. and approximately 700° F., such as in some embodiments between approximately 250° F. and approximately 400° F., such as in some embodiments between approximately 300° F. and approximately 350° F., such as in some embodiments between approximately 400° F. and approximately 650° F. Due to the use of methods and systems according to the present disclosure, fiber reinforced polymer tapes in these embodiments may exit such systems at outlet temperatures generally below a melting temperature for the polymer material, such as in some embodiments between approximately 75° F. and approximately 300° F., such as between approximately 100° F. and approximately 250° F., such as between approximately 150° F. and approximately 200° F., such as between approximately 200° F. and approximately 300° F. Further, such cooling during forming of the fiber reinforced polymer tapes may occur, when utilizing methods and systems according to the present disclosure, at speeds of greater than or equal to approximately 60 feet per minute, such as greater than or equal to approximately 80 feet per minute, such as greater than or equal to approximately 100 feet per minute, such as greater than or equal to approximately 115 feet per minute. Heating may similarly occur at such increased speeds as desired or required.

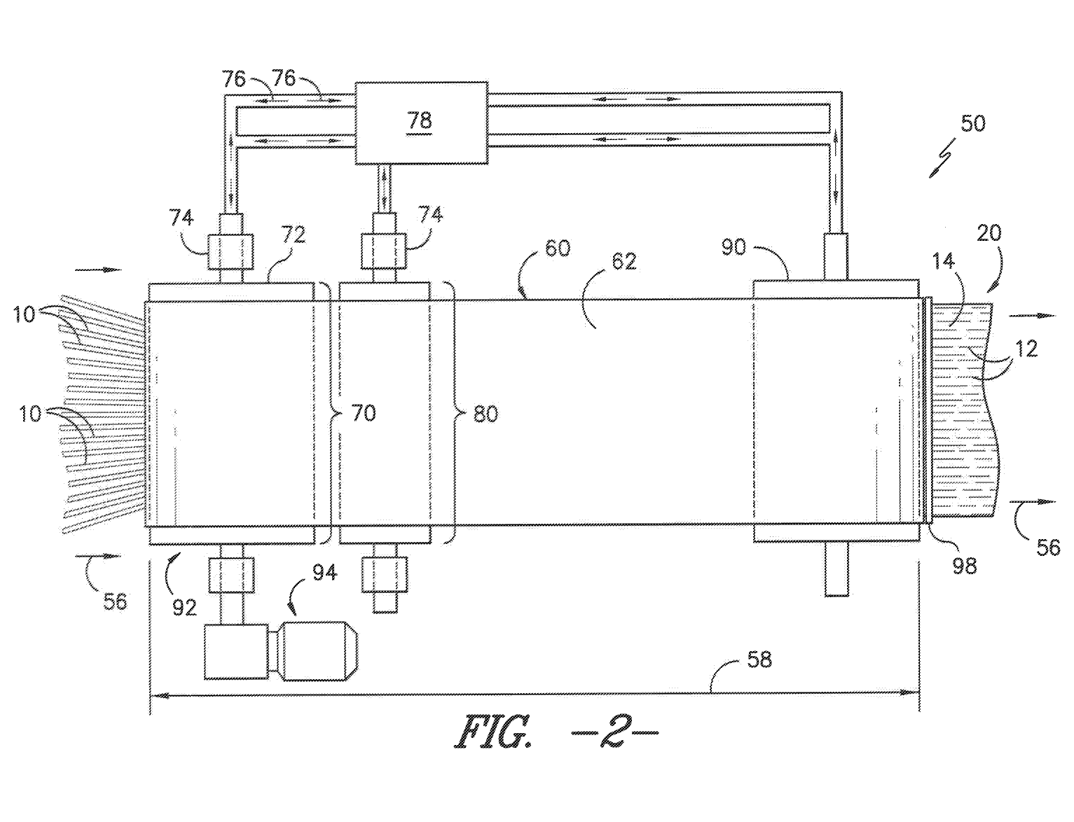

FIG. 2 illustrates a plurality of polymer impregnated ravings 10. As used herein, the term “roving” generally refers to a bundle of individual fibers 12. The fibers 12 contained within the roving can be twisted or can be straight. The rovings may contain a single fiber type or different types of fibers 12. Different fibers may also be contained in individual rovings or, alternatively, each roving may contain a different fiber type. The fibers employed in the rovings possess a high degree of tensile strength relative to their mass. For example, the ultimate tensile strength of the fibers is typically from about 1,000 to about 15,000 Megapascals (“MPa”), in some embodiments from about 2,000 MPa to about 10.000 MPa, and in some embodiments, from about 3,000 MPa to about 6,000 MPa. Such tensile strengths may be achieved even though the fibers are of a relatively light weight, such as a mass per unit length of from about 0.05 to about 2 grams per meter, in some embodiments from about 0.4 to about 1.5 grams per meter. The ratio of tensile strength to mass per unit length may thus be about 1,000 Megapascals per gram per meter (“MPa/g/m”) or greater, in some embodiments about 4,000 MPa/g/m or greater, and in some embodiments, from about 5,500 to about 20,000 MPa/g/m. Carbon fibers are particularly suitable for use as the fibers, which typically have a tensile strength to mass ratio in the range of from about 5,000 to about 7,000 MPa/g/m. The fibers often have a nominal diameter of about 4 to about 35 micrometers, and in some embodiments, from about 9 to about 35 micrometers. The number of fibers contained in each roving can be constant or vary from roving to roving. Typically, a roving contains from about 1,000 fibers to about 50,000 individual fibers, and in some embodiments, from about 5,000 to about 30,000 fibers.

Each roving 10 may be impregnated with a polymer material 14, such that the fibers 12 are generally embedded in the material 14. Any suitable device or apparatus, such as a suitable pultrusion or impregnation die, may be utilized to impregate the rovings 10 with polymer material 14. Multiple polymer impregnated roving 10 may be connected by the polymer material 14, or a polymer impregnated roving 10 may be separate from other polymer impregnated rovings 10, as the rovings 10 enter a system or are subjected to a method according to the present disclosure.

In exemplary embodiments, the polymer material is a thermoplastic material, although it should be understood that systems and methods according to the present disclosure may alternatively be utilized with thermosets. Suitable thermoplastic materials for use according to the present disclosure include, for instance, polyolefins (e.g., polypropylene, propylene-ethylene copolymers, etc.), polyesters (e.g., polybutylene terephalate (“PBT”)), polycarbonates, polyamides (e.g., PAl2, Nylon™), polyether ketones (e.g., polyether ether ketone (“PEEK”)), polyetherimides, polyarylene ketones (e.g., polyphenylene diketone (PPDK″)), liquid crystal polymers, polyarylene sulfides (e.g., polyphenylene sulfide (“PPS”), poly(biphenylene sulfide ketone), poly(phenylene sulfide diketone), poly(biphenylene sulfide), etc.), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes, polycarbonates, styrenic polymers (e.g., acrylonitrile butadiene styrene (“ABS”)), and so forth.

As discussed, polymer impregnated rovings 10 entering a system or being subjected to a method according to the present disclosure include a plurality of fibers 12 therein. In exemplary embodiments, the fibers are continuous fibers, although it should be understood that long fibers may additionally be included therein. As used therein, the term “long fibers” generally refers to fibers, filaments, yarns, or ravings that are not continuous, and as opposed to “continuous fibers” which generally refer to fibers, filaments, yarns, or ravings having a length that is generally limited only by the length of a part. Fiber reinforced polymer tapes 20 that result from use of systems and methods according to the present disclosure may thus include these fibers 12 dispersed in the polymer material 14.

The fibers 12 dispersed in the polymer material 14 may be formed from any conventional material known in the art, such as metal fibers, glass fibers (e.g., E-glass, A-glass, C-glass, D-glass, AR-glass, R-glass, S-glass such as S1-glass or S2-glass), carbon fibers (e.g., graphite), boron fibers, ceramic fibers (e.g., alumina or silica), aramid fibers (e.g., Kevlar® marketed by E. I. duPont de Nemours, Wilmington, Del.), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing polymer compositions. Glass fibers, carbon fibers, and aramid fibers are particularly desirable. In exemplary embodiments, continuous fibers 12 dispersed in a resulting tape may be generally unidirectional, as shown in FIGS. 2, 6 and 7.

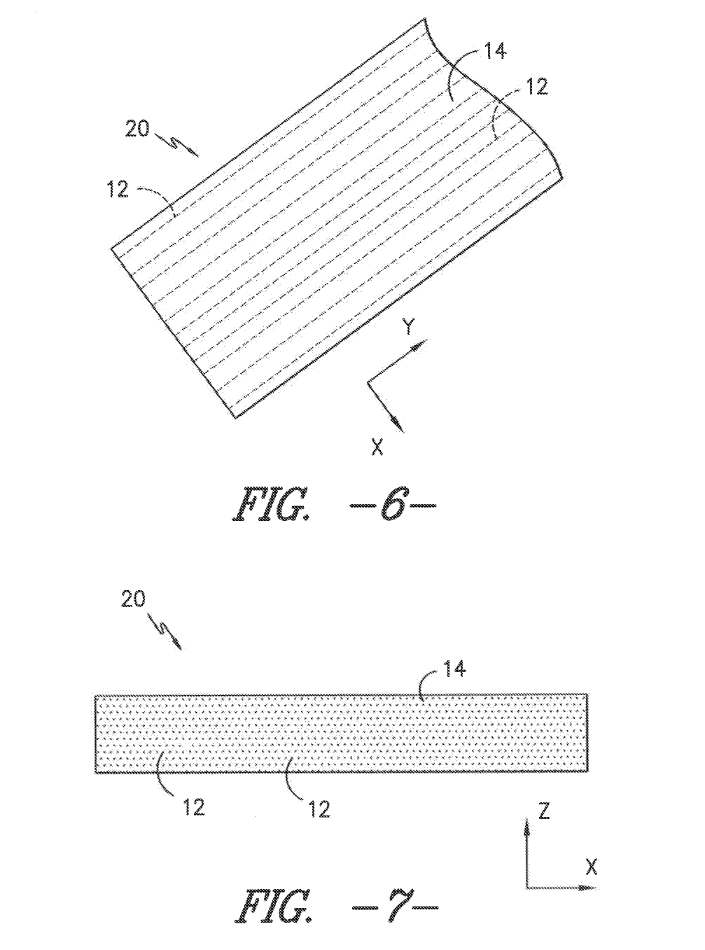

The number of ravings 10 employed in each tape 20 may vary. Typically, however, a tape 20 will contain from 2 to 80 ravings, and in some embodiments from 10 to 60 ravings, and in some embodiments, from 20 to 50 rovings. In some embodiments, it may be desired that the ravings are spaced apart approximately the same distance from each other within the tape 20. In other embodiments, however, it may be desired that the ravings are combined, such that the fibers 12 of the ravings 10 are generally evenly distributed throughout the tape 20. In these embodiments, the rovings may be generally indistinguishable from each other. Referring to FIGS. 6 and 7, for example, embodiments of a tape 20 are shown that contains ravings that are combined such that the fibers 12 are generally evenly distributed therein. As shown in FIG. 6, in exemplary embodiments, the fibers extend generally unidirectionally, such as along a longitudinal axis of the tape 20.

A relatively high percentage of fibers 12 may be employed in a resulting fiber reinforced polymer tape 20 to provide enhanced strength properties. For instance, fibers 12 typically constitute from about 25 wt. % to about 90 wt. %, in some embodiments from about 30 wt. % to about 75 wt %, and in some embodiments, from about 35 wt. % to about 70 wt. % of the tape 20 and material thereof. Likewise, polymer(s) typically constitute from about 20 wt. % to about 75 wt. %, in some embodiments from about 25 wt % to about 70 wt. %, and in some embodiments, from about 30 wt. % to about 65 wt. % of the tape 20. Such percentage of fibers may additionally or alternatively by measured as a volume fraction. For example, in some embodiments, a tape 20 or material thereof may have a fiber volume fraction between approximately 25% and approximately 80%, in some embodiments between approximately 30% and approximately 70%, in some embodiments between approximately 40% and approximately 60%, and in some embodiments between approximately 45% and approximately 55%.

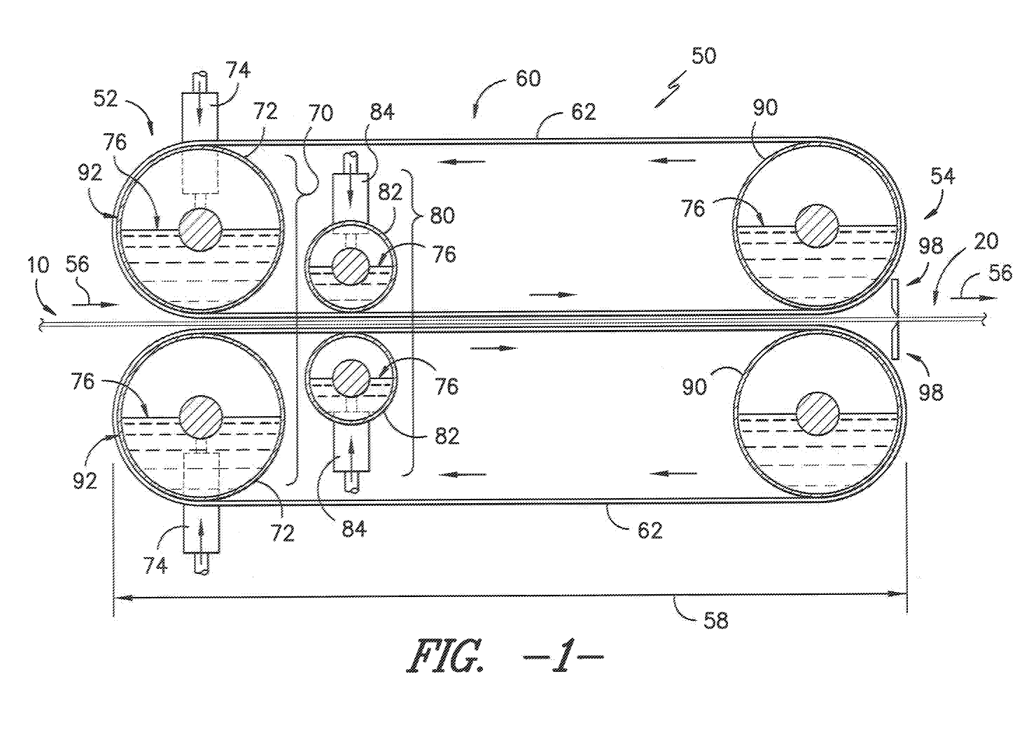

FIGS. 1 through 5 illustrate various embodiments of consolidation systems 50 according to the present disclosure. As discussed above, polymer impregnated rovings 10 may be traversed through a consolidation system 50 and formed into a fiber reinforced polymer tape 20. As shown, a consolidation system 50 may include an inlet 52 and an outlet 54. The outlet 54 may be positioned downstream of the inlet 52 in a traversal direction 56 along which ravings 10 and resulting tapes 20 are traversed. Notably, in some exemplary embodiments, a distance 58 between the inlet 52 and the outlet 54 may be, for example, between approximately 1 foot and approximately 30 feet. Consolidation and adjustment of the temperature of the rovings 10 within this distance 58, as discussed below, may facilitate the production of improved tapes 20 at increased speeds. Further, various devices and apparatus are included within the consolidation system 50 apply pressure to and adjust the temperature of the rovings 10 being traversed therethrough. Such devices and apparatus advantageously provide increased retention time and improved temperature adjustment of the rovings 10, while allowing the consolidation system 50 to operate at increased speeds.

For example, system 50 may include a heat transfer device 60. The heat transfer device 60 may be disposed between the inlet 52 and the outlet 64, and may be operable to adjust a temperature of the roving 10 as the roving is traversed between the inlet 52 and the outlet 54. As discussed below, the heat transfer device 60 may generally have a temperature that is different from a temperature of the roving 10 at the inlet 52, such as different from a melting temperature of the polymer material of the roving 10. For example, in some embodiments the heat transfer device 60 may be a cooling device, with a temperature thereof that may be for example between approximately 32° F. and slightly below the melting temperature of the polymer material of the roving 10. In other embodiments, the heat transfer device 60 may be a heating device, with a temperature thereof that may be for example greater than or equal to the melting temperature of the polymer material of the roving 10.

In some embodiments, as shown in FIGS. 1 through 3, a heat transfer device 60 may include a plurality of belts 62, such as two opposing belts 62 as shown, extending between the inlet 52 and the outlet 54. The ravings 10, when introduced into the system 50 at the inlet 52, may be fed between the belts 62. Each belt 62 may thus be in direct contact with the rovings 10 as the rovings are traversed through the system 50 and formed into tape 20. Further, movement of the belts 62 may cause the traversal of the rovings 10 therethrough. In exemplary embodiments as discussed below, the belts 62 may be driven by roller movably coupled thereto.

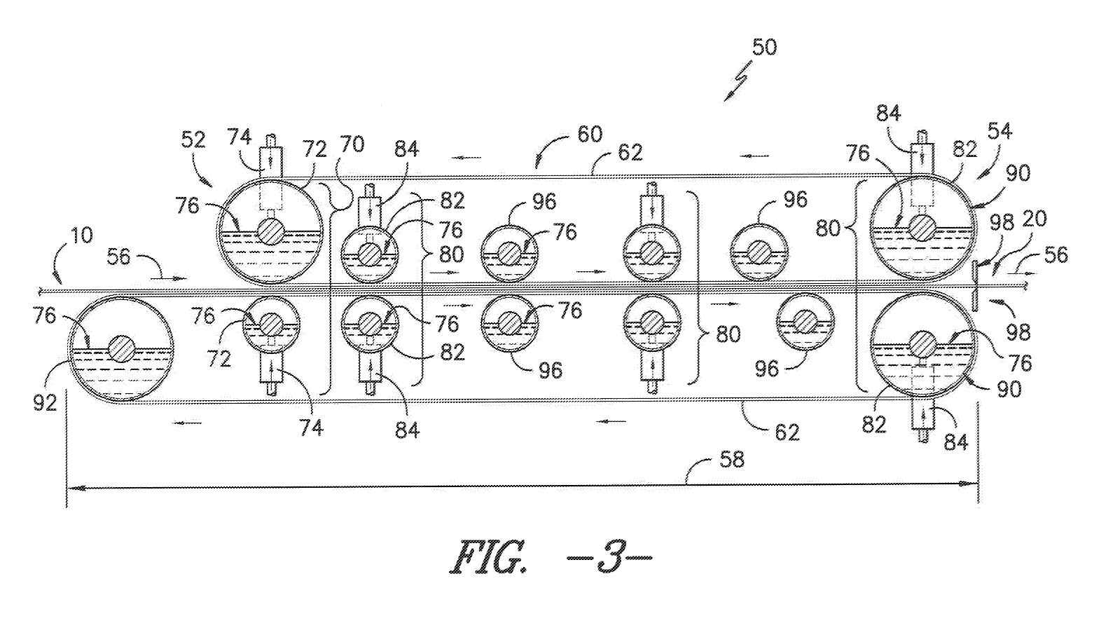

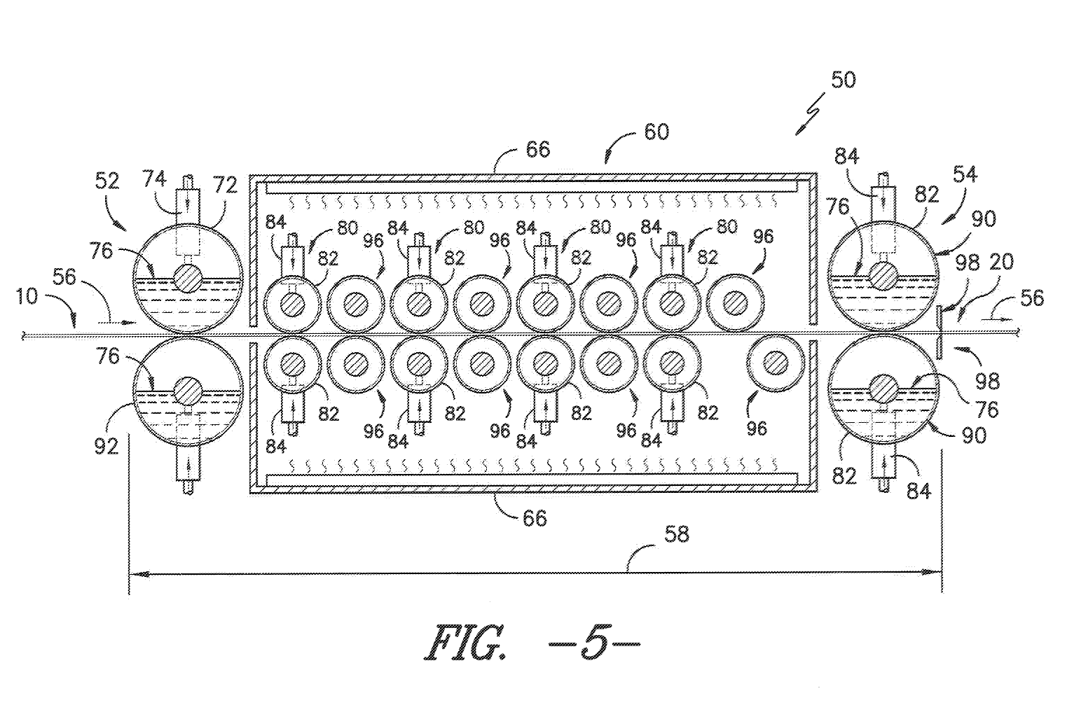

In exemplary embodiments as shown, each belt 62 may maintain generally continuous contact with the rovings 10 as the rovings 10 are traversed between the inlet 52 and the outlet 54. Direct contact of each belt 62 with the rovings 10 may facilitate consolidation of the ravings 10 into a tape 20, and may further adjust the temperature of the rovings 10 and resulting tape 20. For example, the belt 62 may be cooled or heated during operation of the system 50. Such cooling or heating may be facilitated through contact by the belts 62 with other cooled or heated components, as discussed below, or through direct cooling or heating of the belts 62. For example, in some embodiments, a chiller (not shown), heater (not shown) or heat transfer chamber (see FIG. 5) may be disposed in the system 50 such that a belt 62 runs through the chiller, heater or heat transfer chamber during operation thereof, thus adjusting a temperature of the belt 62 to a desired cooling or heating temperature. For example, the chiller, heater or heat transfer chamber may be positioned to cool or heat portions of the belt 62 between contact by these portions with rovings 10. Alternatively, other components, such as rollers as discussed below, may be cooled or heated. The cooled or heated rollers or other components may then, due to contact and resulting heat transfer with a belt 62, cool or heat the belt 62. In exemplary embodiments wherein the belts 62 are cooled, belts 62 according to the present disclosure may be cooled to cooling temperatures less than a temperature of the roving 10 at the inlet 52, such as less than a melting temperature of the polymer material of the impregnated rovings 10 being traversed therethrough, such as in some embodiments between approximately 32° F. and slightly below the melting temperature. In exemplary embodiments wherein the belts 62 are heated, belts 62 according to the present disclosure may be heated to heating temperatures greater or equal to a temperature of the roving 10 at the inlet 52, such as greater than or equal to a melting temperature of the polymer material of the impregnated rovings 10 being traversed therethrough. The temperature of the belt 62 may be measured at a location on a belt 62 during operation immediately before the belt 62 contacts rovings 10 and thus begins adjusting a temperature of the rovings 10. Further, notably, because the belts 62 extend between the inlet 52 and the outlet 54, contact by the belts 62 over the distance 58 between the inlet 52 and outlet 54 may facilitated desired consolidation and cooling or heating at increased speeds. It should be noted that in some embodiments, one or more belts 62 may extend beyond the inlet 54, as shown in FIG. 3, or beyond the outlet 54.

Belts 62 utilized according to the present disclosure may be formed from any suitable material, but are typically smooth, with low-wear, low-friction surfaces.

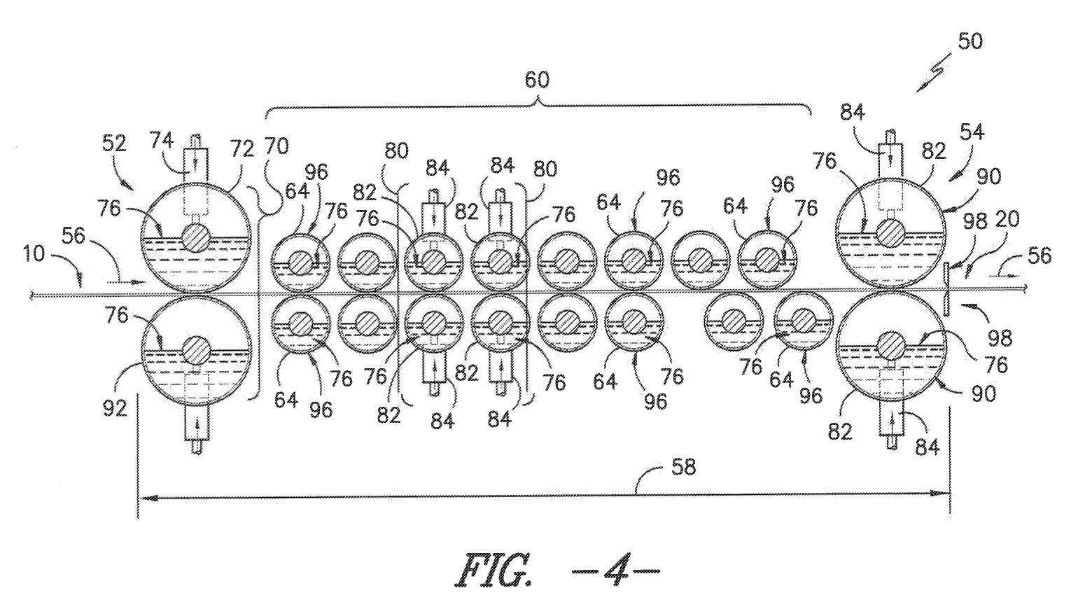

In other embodiments, as shown in FIG. 4, a heat transfer device 60 may include a plurality of rollers 64, such as one or more pairs of opposing rollers 64 and/or offset rollers 64. Such rollers 64 may be cooled or heated. The cooled or heated rollers 64 may contact the rovings 10 and resulting tape 20, thus adjusting the temperature of the ravings 10 and resulting tape 20. As shown, a heat transfer medium 76 may be disposed within one or more rollers 64. The heat transfer medium may be a cooling medium or a heating medium, and in exemplary embodiments may be a fluid, such as water, glycol, a glycol-water mixture, or any other suitable fluid. Alternatively, the heat transfer medium may be gas. The temperature of the heat transfer medium 76 may be such that heat transfer between the heat transfer medium 76 and rollers 64 results in the rollers 64 being at heating or cooling temperatures as discussed above.

Further, the heat transfer medium 76 may in exemplary embodiments be cycled between the rollers 64 and a heat adjuster 78 (see FIG. 2), such as a chiller or heater, to chill or heat the heat transfer medium 76. Examples of suitable chillers include air cooled central, portable and fixed chillers; water-cooled central, portable and fixed chillers; heat transfer fluid heat exchangers; steam or other fluid heat exchangers; cooling towers; chillers of filtered well water or river water containers; cold shot medical chillers; and refrigerant cooled chillers. Examples of suitable heaters include central, portable and fixed heaters, infrared heaters, electric heaters, gas powered heaters, heat exchangers, etc. The heat transfer medium 76 may be continually cycled during operation of the system 50 such that the heat transfer medium 76 disposed within the rollers 64 constantly cools or heats the rollers 64, resulting in constant cooling or heating of the rovings 10 and resulting tape 20.

In other embodiments, as shown in FIG. 5, a heat transfer device 60 may include one or more heat transfer chambers 66, such as two opposing heat transfer chambers 66 as shown. A heat transfer chamber 66 is generally a chamber that includes or is chilled or heated by, for example a chiller or heater as discussed above. A temperature within the heat transfer chamber 66 may be at a cooling temperature or heating temperature as discussed above. As shown, the rovings 10 may be traversed past or between the heat transfer chambers. Heat transfer between the heat transfer chambers 66 and the rovings 10 may adjust the temperature of the rovings 10 and resulting tape 20.

It should be noted that, in some embodiments, various rollers may additionally be included within a heat transfer chamber 66 as shown. Such rollers may themselves be cooled or heated, by virtue of being cooled or heated rollers 64 (not shown) or by virtue of heat transfer between the rollers and the chilled chamber 66.

A system 50 according to the present disclosure may further include a consolidation pressure device 70. The consolidation pressure device 70 may be operable to apply a consolidation pressure to the rovings 10 within the system 50 as the rovings 10 are traversed between the inlet 52 and the outlet 54. Thus, operation of the device 70 may, for example, apply a consolidation pressure to the rovings 10 either directly, as shown in FIGS. 4 and 5, or through the belts 62 such that the belts 62 directly contact the rovings 10, as shown in FIGS. 1 and 3, at the location of the device 70 at the desired consolidation pressure. In general, the consolidation pressure may be a generally constant pressure applied during operation and traversal therethrough of rovings 10, such that the resulting tape 20 is generally fully consolidated and, in exemplary embodiments, generally uniform in shape and size. Such consolidation pressure may facilitate consolidation of the rovings 10 into the tape 20 within the system 50. In exemplary embodiments, the consolidation pressure device 70 is disposed at or proximate to the inlet 52. Further, in exemplary embodiments, the consolidation pressure is between approximately 100 pounds per square inch and approximately 22,000 pounds per square inch.

In exemplary embodiments, as shown, a consolidation pressure device 70 may include a plurality of rollers 72, such as inlet rollers 72 disposed at the inlet 52. One or more of the rollers 72 may apply the consolidation pressure. As shown, for example, pairs of opposing rollers 72 may be operable to apply a pressure, such that the consolidation pressure is applied to the rovings 10. In embodiments wherein belts 62 are utilized, a roller 72 may further be movably coupled to a belt 62, such that movement of the belt 62 rotates the roller 72 or rotation of the roller 72 moves the belt 62.

Any suitable devices or apparatus may be utilized to operate the rollers 72, or other suitable apparatus of the consolidation pressure device 70, to apply the consolidation pressure. In some embodiments as shown, hydraulic cylinders 74 may be attached to the rollers 72 or other suitable apparatus. The hydraulic cylinders 74 may be actuated to drive the rollers 72 or other suitable apparatus inward towards the rovings 10, thus applying the consolidation pressure to the rovings 10. Alternatively, pneumatic or otherwise pressurized cylinders, gear assemblies, other suitable mechanical assemblies, or other suitable devices or apparatus may be utilized.

In further exemplary embodiments, one or more rollers 72 may be cooled or heated. The cooled or heated rollers 72 may further, due to contact between the rollers 72 and rovings 10 or the belts 62, cool or heat the ravings 10 and resulting tapes 20 directly or cool or heat the belts 62 such that such contact cools or heats the rovings 10 and resulting tape 20. As shown, a heat transfer medium 76 may thus additionally or alternatively be disposed within one or more rollers 72. As discussed, the temperature of the heat transfer medium 76 may be such that heat transfer between the heat transfer medium 76, rollers 72, and optional belts 62 results in the rollers 72 or belts 62 being at cooling or heating temperatures as discussed above.

Further, as discussed, the heat transfer medium 76 may in exemplary embodiments be cycled between the rollers 72 and a heat adjuster 78 to chill or heat the heat transfer medium 76. The heat transfer medium 76 may be continually cycled during operation of the system 50 such that the heat transfer medium 76 disposed within the rollers 72 constantly cools or heats the rollers 72, resulting in constant cooling or heating of the rovings 10 and resulting tape 20 by the rollers 72 or belts 62.

A system 50 according to the present disclosure may further include a shaping pressure device 80. The shaping pressure device 80 may be operable to apply a shaping pressure to the ravings 10 within the system 50 as the rovings 10 are traversed between the inlet 52 and the outlet 54, such as downstream of the consolidation pressure device 70. Thus, operation of the device 80 may, for example, apply a shaping pressure to the rovings 10 either directly, as shown in FIGS. 4 and 5, or through the belts 62 such that the belts 62 directly contact the rovings 10, as shown in FIGS. 1 and 3, at the location of the device 80 at the desired shaping pressure. In general, the shaping pressure may be a generally constant pressure applied during operation and traversal therethrough of rovings 10, such that the resulting tape 20 is generally fully consolidated and, in exemplary embodiments, generally uniform in shape and size. Such shaping pressure may facilitate shaping of the rovings 10 into the tape 20 within the system 50 after consolidation thereof, and during cooling or heating thereof. In exemplary embodiments, the shaping pressure device 80 is disposed downstream of the consolidation device 70. Further, in exemplary embodiments, the shaping pressure is less than the consolidation pressure, such as between approximately 100 pounds per square inch and approximately 8,000 pounds per square inch.

In exemplary embodiments, as shown, a shaping pressure device 80 may include a plurality of intermediate rollers 82. One or more of the rollers 82 may apply the shaping pressure. As shown, for example, pairs of opposing rollers 82 may be operable to apply a pressure, such that the shaping pressure is applied to the ravings 10. In embodiments wherein belts 62 are utilized, a roller 82 may further be movably coupled to a belt 62, such that movement of the belt 62 rotates the roller 82 or rotation of the roller 82 moves the belt 62.

Any suitable devices or apparatus may be utilized to operate the rollers 82, or other suitable apparatus of the shaping pressure device 80, to apply the shaping pressure. In some embodiments as shown, hydraulic cylinders 84 may be attached to the rollers 82 or other suitable apparatus. The hydraulic cylinders 84 may be actuated to drive the rollers 82 or other suitable apparatus inward towards the rovings 10, thus applying the shaping pressure to the rovings 10. Alternatively, pneumatic cylinders, gear assemblies, or other suitable devices or apparatus may be utilized.

In further exemplary embodiments, one or more rollers 82 may be cooled or heated. The cooled or heated rollers 82 may further, due to contact between the rollers 82 and the ravings 10 or the belts 62, cool or heat the ravings 10 and resulting tapes 20 directly or cool or heat the belts 62 such that such contact cools or heats the ravings 10 and resulting tape 20. As shown, heat transfer medium 76 may additionally or alternatively be disposed within one or more rollers 82. As discussed, the temperature of the heat transfer medium 76 may be such that heat transfer between the heat transfer medium 76, rollers 82, and optional belts 62 results in the rollers 82 or belts 62 being at cooling or heating temperatures as discussed above.

Further, as discussed, the heat transfer medium 76 may in exemplary embodiments be cycled between the rollers 82 and a heat adjuster 78 to chill or heat the heat transfer medium 76. The heat transfer medium 76 may be continually cycled during operation of the system 50 such that the heat transfer medium 76 disposed within the rollers 82 constantly cools or heats the rollers 82, resulting in constant cooling or heating of the rovings 10 and resulting tape 20 by the rollers 82 or belts 62.

As shown, other various rollers may be included in a system 50. For example, outlet rollers 90 may be utilized. The outlet rollers 90 may be disposed at the outlet 54, and may optionally be movably coupled to the belts 62. Further, drive rollers 92 may be utilized. A drive roller 92 may be a roller 92 that is, for example, coupled to a motor to drive a portion of the system 50, such as a belt 62 and/or associate other rollers. A drive roller 92 may be separate from other rollers, such as rollers 64, 72, 82, and/or 90, as shown in FIG. 3, or may be a roller 64, 72, 82 and/or 90 as shown in FIGS. 1 through 3. A motor 94 may be coupled to the drive roller 92 to drive the roller 92 and optional associated belt 62, etc. Further, as shown in FIG. 3, secondary intermediate rollers 96 may be utilized. The secondary intermediate rollers 96 may be disposed between the inlet 52 and the outlet 54, and may optionally be movably coupled to the belts 62.

It should be noted that outlet rollers 90, drive rollers 92, and/or secondary intermediate rollers 96 according to the present disclosure may be cooled or heated, such as through the use of heat transfer medium 76 disposed therein as discussed above, as desired. It should also be noted that outlet rollers 90, drive rollers 92, and/or secondary intermediate rollers 96 according to the present disclosure may apply a suitable pressure to the rovings 10 and resulting tape 20, such as through attachment to hydraulic cylinders or other suitable devices or apparatus, as desired. It should additionally be noted that rollers according to the present disclosure may be disposed in opposing pairs, as shown in FIGS. 1, 3, 4 and 5, or may be offset from each other on opposing sides of the rovings 10 and resulting tapes 20, as shown in FIGS. 3, 4 and 5, or may have any other suitable arrangement as desired or required.

Further, any other suitable devices or apparatus may be utilized in consolidation pressure devices 70 and/or shaping pressure devices 80 according to the present disclosure. Such suitable devices or apparatus may be operable to apply consolidation and shaping pressures as disclosed herein during traversal of the rovings 10 and resulting tapes 20 through the system 50.

Further, it should be understood that a system 50 according to the present disclosure may perform only cooling, only heating, or a combination of heating and cooling. For example, in some embodiments, rovings 10 and resulting tapes 20 may be initially heated, and then cooled, in the present system 50, or vice versa.

Additionally, in exemplary embodiments, various trimming devices may be utilized in a system 50 according to the present disclosure. Such trimming devices may be utilized to trim and further shape the outer surfaces of the tape 20 exiting the system 50, such that the tape 20 has a desired thickness, the outer surfaces are generally uniform, and/or excess polymer material 14, etc. is removed. For example, in some embodiments as shown, one or more doctor's blades 98 may be utilized. The doctor's blades 98, such as opposing doctor's blades 98 as shown, may be positioned at or downstream of the outlet 54 to trim the tape 20 as the tape 20 exits the system 50.

The present disclosure is further directed to methods for forming fiber reinforced polymer tapes 20. A method according to the present disclosure may include, for example, traversing one or more polymer impregnated rovings 10 through a system, such as a system 50, comprising an inlet 52 and an outlet 54. A method may further include applying a consolidation pressure and a smoothing pressure within the system to the rovings 10. In exemplary embodiments, the consolidation pressure and smoothing pressure may be applied by rollers, as discussed above. The method may further include adjusting a temperature of the rovings 10 with a heat transfer device 60 between the inlet 52 and outlet 54, such as through heating and/or cooling as discussed above. The heat transfer device has a temperature different from a temperature of the rovings 10 at the inlet, such that the rovings are cooled or heated between the inlet 52 and the outlet 54. For example, the heat transfer device may, during operation, be at a cooling temperature or heating temperature as discussed above.

In some embodiments, a method according to the present disclosure may include cycling a heat transfer medium 76 within the system 10, such as through rollers as discussed above. Further, in some embodiments, a method according to the present disclosure may include trimming a tape 20, such as when the tape 20 is exiting the system 50.

The tapes 20 that result from use of devices and methods according to the present disclosure may have a very low void fraction, which helps enhance their strength. For instance, the void fraction may be about 5% or less, in some embodiments about 4% or less, in some embodiments about 3% or less, in some embodiments about 2% or less, in some embodiments about 1.5% or less, in some embodiments about 1% or less, and in some embodiments, about 0.5% or less. The void fraction may be measured using techniques well known to those skilled in the art. For example, the void fraction may be measured using a “resin burn off” test in which samples are placed in an oven (e.g., at 600° C. for 3 hours) to burn out the resin. The mass of the remaining fibers may then be measured to calculate the weight and volume fractions. Such “burn off” testing may be performed in accordance with ASTM D 2584-08 to determine the weights of the fibers and the polymer matrix, which may then be used to calculate the “void fraction” based on the following equations:

V_{f}=100*(ρₜ−ρ_{c})/ρₜ

where,

V_{f} is the void fraction as a percentage;

ρ_{c} is the density of the composite as measured using known techniques, such as with a liquid or gas pycnometer (e.g., helium pycnometer);

ρₜ is the theoretical density of the composite as is determined by the following equation:

ρₜ=1/[W_{f}/ρ_{f}+Wₘ/ρₘ]

ρₘ is the density of the polymer matrix (e.g., at the appropriate crystallinity);

ρ_{f} is the density of the fibers;

W_{f} is the weight fraction of the fibers; and

Wₘ is the weight fraction of the polymer matrix.

Alternatively, the void fraction may be determined by chemically dissolving the resin in accordance with ASTM D 3171-09. The “burn off” and “dissolution” methods are particularly suitable for glass fibers, which are generally resistant to melting and chemical dissolution. In other cases, however, the void fraction may be indirectly calculated based on the densities of the polymer, fibers, tape and/or rod in accordance with ASTM D 2734-09 (Method A), where the densities may be determined ASTM D792-08 Method A. Of course, the void fraction can also be estimated using conventional microscopy equipment.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method for forming a fiber reinforced polymer tape, the method comprising:
traversing a polymer impregnated roving through a system comprising an inlet and an outlet;
applying a consolidation pressure within the system to the polymer impregnated roving;
applying a smoothing pressure within the system to the polymer impregnated roving; and
adjusting a temperature of the polymer impregnated roving with a heat transfer device between the inlet and the outlet, the heat transfer device having a temperature different from a temperature of the polymer impregnated roving at the inlet.

2. The method of claim 1, wherein the consolidation pressure is between approximately 100 pounds per square inch and approximately 22,000 pounds per square inch.

3. The method of claim 1, wherein the smoothing pressure is between approximately 100 pounds per square inch and approximately 8,000 pounds per square inch.

4. The method of claim 1, wherein the heat transfer device is a cooling device, wherein the temperature of the polymer impregnated roving at the inlet is above a melting temperature for a polymer material of the polymer impregnated roving, and wherein the temperature of the fiber reinforced polymer tape at the outlet is below a melting temperature for the polymer material of the polymer impregnated roving.

5. The method of claim 1, wherein the heat transfer device comprises a belt extending between the inlet and the outlet.

6. The method of claim 1, wherein the adjusting step comprises continuously contacting the polymer impregnated roving between the inlet and the outlet with the cooling device.

7. The method of claim 1, wherein the heat transfer device comprises a plurality of rollers.

8. The method of claim 1, wherein the heat transfer device comprises a heat transfer chamber.

9. The method of claim 1, wherein the consolidation pressure and the smoothing pressure are applied by rollers.

10. The method of claim 1, further comprising cycling a heat transfer medium within the system.

11. The method of claim 1, wherein a distance between the inlet and the outlet is between approximately 2 feet and approximately 20 feet.

12. The method of claim 1, wherein the polymer is a thermoplastic.

13. A system for forming a fiber reinforced polymer tape, the system comprising:
an inlet;
an outlet positioned downstream of the inlet;
a consolidation pressure device operable to apply a consolidation pressure to a polymer impregnated roving as the polymer impregnated roving is traversed between the inlet and the outlet;
a shaping pressure device operable to apply a shaping pressure to the polymer impregnated roving as the polymer impregnated roving is traversed between the inlet and the outlet; and
a heat transfer device disposed between the inlet and the outlet, the heat transfer device operable to adjust a temperature of the polymer impregnated roving between the inlet and the outlet.

14. The system of claim 13, wherein the consolidation pressure device comprises a plurality of inlet rollers disposed at the inlet, the plurality of inlet rollers applying the consolidation pressure.

15. The system of claim 14, further comprising a heat transfer medium disposed within each of the plurality of inlet rollers.

16. The system of claim 15, wherein contact between each of the plurality of belts and the plurality of inlet rollers adjusts a temperature of each of the plurality of belts, such that contact between each of the plurality of belts and the polymer impregnated roving adjusts the temperature of the polymer impregnated roving.

17. The system of claim 15, further comprising a heat adjuster, and wherein the heat transfer medium is cycled between each of the plurality of inlet rollers and the heat adjuster.

18. The system of claim 13, wherein the shaping pressure device comprises a plurality of intermediate rollers disposed between the inlet and the outlet, the plurality of intermediate rollers applying the shaping pressure.

19. The system of claim 13, further comprising a plurality of outlet rollers disposed at the outlet.

20. The system of claim 13, wherein the heat transfer device comprises a plurality of belts, each of the plurality of belts extending between the inlet and the outlet, each of the plurality of belts operable to contact and adjust the temperature of the polymer impregnated roving between the inlet and the outlet.

21. The system of claim 20, wherein each of the plurality of belts is operable to continuously contact the polymer impregnated roving between the inlet and the outlet.

22. The system of claim 13, wherein the heat transfer device comprises a plurality of rollers.

23. The system of claim 13, wherein the heat transfer device comprises a heat transfer chamber.

24. The system of claim 13, further comprising a hydraulic cylinder connected to the consolidation pressure device, the hydraulic cylinder operable to cause the consolidation pressure device to apply the consolidation pressure.

25. The system of claim 13, further comprising a plurality of doctor blades disposed at the outlet.

26. The system of claim 13, wherein the polymer is a thermoplastic.
